(19) United States
(12) Patent Application Publication
(10) Pub. No.: US 2006/0184438 A1
(43) Pub. Date: Aug. 17, 2006

(54) Fund management system and method

(76) Inventor: Ronald A. McDow, Nashville, TN (US)

Correspondence Address: George W. Rauchfuss, Jr., Esq.;Ohlandt, Greeley, Ruggiero & Perle, L.L.P., 10th Floor, One Landmark Square, Stamford, CT, 06901-2682, US

(21) Appl. No.: 11/269,435

(22) Filed: Nov. 8, 2005

Related U.S. Application Data
(60) Provisional application No. 60/625,867, filed on Nov. 8, 2004.

(51) Int. Cl. G06Q 40/00

(52) U.S. Cl. 705/35

(57) ABSTRACT

A dynamic and flexible method, system and apparatus for managing index mutual funds and index exchange traded funds (ETFs) through using and measuring Relative Strengths and Alphas of the underlying index components to periodically reweight the underlying index components. These reweightings are used in the daily rebalancing of the respective index mutual funds/ETFs to decrease market risk and seek to improve returns above those of the statically weighted index. The disclosure demonstrates how various mutual fund/ETF indexes are flexibly weighted according to Relative Strength and Alpha calculations each standing alone or used in combination. The determination of the relative weights of Relative Strength and Alpha can be made periodically by management using a back testing and computer optimization process. After periodic determination of index component weights the mutual fund/ETF index portfolio rebalancing can occur daily, multiple intervals intraday, or any interval which conforms to regulatory requirements. Portfolios suitable for this method and apparatus include equity, bonds, or hybrids (equity and bonds).

### RELATED APPLICATION

This Application claims the benefit of U.S. Provisional Application No. 60/625,867, filed on Nov. 8, 2004.

### FIELD OF THE INVENTION

This invention relates to a system and method that manages a fund of financial instruments based on relative strength, weighting, alphas and rebalancing.

### BACKGROUND OF THE INVENTION

Mutual Funds, which had their origin in 1925, have been classified into one of two categories. The first category is those mutual funds that are actively managed portfolios that consist of stocks specifically chosen for that portfolio. Fundamental analysis (evaluation of a company's earning prospects) was used in the decision process when creating and managing this category of mutual fund. The second category is mutual funds that consist of an index that was created and maintained by entities such as Standard and Poor and Dow Jones Indexes. These indexes are generally recognized by the marketplace as proxies for the sector of the market that they represent. Investors believe that a particular sector or the market will do well in the future or simple want broad exposure to the market with great diversification among stocks purchase these indexes and hold for various periods of time.

Exchange Traded Index Funds (ETFs), a more recent innovation coming into existence in the last 10 years, seek to track various indexes, are traded on an established exchange (currently primarily the New York and American Exchanges). ETFs offer the investor the opportunity for real time exchanges in and out of a number of recognized indexes through use of a broker. ETFs have a structure that allows investors more numerous opportunities for exchanges and relatively lower expense ratios but investors often face decrease liquidity of their shares and incur commission expenses for exchanges in and out that are absorbed by equivalently structured mutual funds.

### DESCRIPTION OF INDEXES

Indexes are most commonly market capitalization (free floating shares) weighted. That is, the index components with the largest total market capitalization are weighted the heaviest within the index. Some indexes are equal weighted with each component assigned an equal weight within the index. At least one index is price weighted with the highest priced security component receiving the greatest weight and the lowest priced component receiving the least weight. The common feature is that these market indexes have permanent fixed weightings that are assigned by the sponsoring entity and managed in a completely passive manner. The mutual fund companies/ETFs who use these indexes for their funds seek to emulate the stated fixed weightings exactly regardless of changing market conditions or changing performance of the indexes components.

The sponsoring companies for these indexes usually make additions or deletions to their indexes yearly or less frequently by removing some old names and adding new names while maintaining the Index's fixed weightings. The reasons for these deletions are usually due to poor performance by index components. The reasons for index additions include a company with strong growth and rising prospects within its index sector in terms of company size or importance. These changes are made by the sponsoring index companies on an as needed basis.

Investors can own an index that correlates with the broad market (i.e. S&P 500), large cap old line industrial stocks (Dow Industrials), and a broad market sector (i.e. Dow Transportation or Dow Utilities). Investors can choose to own a more defined and narrow market sector (i.e. SOX semiconductor index, XAU gold index, XOI Oil index, Morgan Stanley Internet Index, GSTI Multimedia Networking Index). In addition, indexes have been created to give exposure to certain regions of the world (Europe Dow Jones Stock 50, Emerging Markets Index) or individual large countries (i.e. Germany DAX 30, France—CAC40, Great Britain—FTSE 100). Country funds also include many smaller geographical regions (i.e., Netherlands AEX Index—Amsterdam Stock Exchange, Spain IBEX 35 index Madrid Stock Exchange, Brazil—Bovespa—BVSP index, Australia—All Ordinaries—AORD Index). Indexes known as style indexes have also been created to invest in a particular market cap size stock (i.e. Russell 2000 small capitalization, mid cap S&P 600). The above are examples but not a complete list of index types.

Examples of Bond Index Funds can include Corporate Bonds (short, medium, and long term), High Yield (junk bonds), mortgage-backed bonds (Ginnie Maes), Treasury Bonds as quoted by primary Treasury bonds dealers, Tax Free Municipal Bonds, Special Agency. Local, and State issue bonds.

Real Estate Investment Trust constituents are another example to apply this system.

Index funds provide several benefits to investors. A large number of security components provide portfolio diversity reducing unique stock risk within a portfolio. In addition, fairly large sums of money can be rapidly invested in indexes because of the large number of securities in the index that absorb the capital with negligible price slippage.

To date index investing has remained a completely passive task. A mutual fund company/ETF currently seeks to offer its customers an exact replication of an index's performance by replicating the security components exactly as well as replicating the fixed weighted structure presented by the creator of the index. (i.e., Dow Jones Indexes and Standard and Poor).

### SUMMARY OF THE INVENTION

A system of the present invention manages a fund portfolio that includes a plurality of components. The system comprises a computer that includes a program that is executed at a repetitive frequency. The program comprises a plurality of instructions that cause the computer to calculate at least one dynamic characteristic of the components based on current price data for each of the components, rank the components in descending order based on the calculated characteristics and rebalance the fund portfolio based on a weighting strategy that is applied to the descending order rank.

In one embodiment of the system, the characteristic is selected from the group consisting of: relative strength, alpha and both relative strength and alpha.

In another embodiment of the system, the fund portfolio is rebalanced using net funds available from customers based on buy and sell orders of the fund.

In another embodiment of the system, the repetitive frequency is selected from the group consisting of: yearly, monthly, weekly, daily and any fraction thereof.

In another embodiment of the system, the fund is selected from the group consisting of: index fund, exchange traded fund, real estate investment trust, and bond fund.

In another embodiment of the system, the weighting strategy comprises a first weighting factor to overweight better performing components and a second weighting factor to underweight lesser performing components.

In another embodiment of the system, the first and second weighting factors are applied to a first predetermined number of top and a second predetermined number of bottom components of the descending order list, respectively.

In another embodiment of the system, the instructions further cause the computer to adjust the weighting strategy at any time based on operator input.

In another embodiment of the system, the calculation of the dynamic characteristic is further based on a like characteristic of a broad or underlying index.

A method of the present invention manages a fund portfolio that includes a plurality of components. The method comprises using a computer that includes a program that is executed at a repetitive frequency. The program comprises a plurality of instructions that cause the computer to perform a plurality of steps comprising calculating at least one dynamic characteristic of the components based on current price data for each of the components, ranking the components in descending order based on the calculated characteristics and rebalancing the fund portfolio based on a weighting strategy that is applied to the descending order rank.

In one embodiment of the method, the characteristic is selected from the group consisting of: relative strength, alpha and both relative strength and alpha.

In another embodiment of the method, the fund portfolio is rebalanced using net funds available from customers based on buy and sell orders of the fund.

In another embodiment of the method, the repetitive frequency is selected from the group consisting of: yearly, monthly, weekly, daily and any fraction thereof.

In another embodiment of the method, the fund is selected from the group consisting of: index fund, exchange traded fund, real estate investment trust, and bond fund.

In another embodiment of the method, the weighting strategy comprises a first weighting factor to overweight better performing components and a second weighting factor to underweight lesser performing components.

In another embodiment of the method, the first and second weighting factors are applied to a first predetermined number of top and a second predetermined number of bottom components of the descending order list, respectively.

In another embodiment of the method, the instructions further cause the computer to adjust the weighting strategy at any time based on operator input.

In another embodiment of the method, the calculation of the dynamic characteristic is further based on a like characteristic of a broad or underlying index.

A memory media of the present invention is for a computer that comprises a stored program with a plurality of instructions that cause the computer to calculate at least one dynamic characteristic of the components based on current price data for each of the components, rank the components in descending order based on the calculated characteristics, and rebalance the fund portfolio based on a weighting strategy that is applied to the descending order rank.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a block diagram depicting a system in which the present invention may be used;

FIG. 2 is a block diagram of a computer of the system of FIG. 1; and

FIGS. 3-10 are flow diagrams depicting the operations of the Fund Management program of the computer of FIG. 2.

### DESCRIPTION OF THE PREFERRED EMBODIMENT

An alternative to actively managed mutual fund and completely passively managed mutual fund index portfolio would be to create a third category of mutual fund. The mutual fund would be described as a semi-passive index fund portfolio structure. No active fundamental research would be done on any securities eliminating huge research costs. All components of the index would be retained. However, the mutual fund's/ETF index components would be weighted and reweighted periodically to emphasize index component securities which are predicted to appreciate faster in the future than the underlying index to which they belong. The index would under emphasize index component securities, which are predicted to under perform the underlying index to which the security component belongs. By employing this process diversification and the relatively low management cost of indexes as compared to actively managed funds would be maintained through use of computers to optimize the weightings. The method and process to achieve these relative weightings and reweighting is described.

Method and Process

The method describes a way for mutual funds/ETFs to balance and rebalance the fund indexes in a manner to achieve superior price performance in comparison to the statically weighted indexes. The US Security and Exchange Commission currently requires mutual funds to balance once a day (ETFs real time) by pricing all mutual funds and providing the index's owner with a value know as net asset value (NAV). More frequent intraday balancing can and does occur. Currently, Fidelity Sector Funds balances their sector funds each hour establishing a net asset value for these indexes at each interval. The fund family/ETF creator using this balancing process will most likely continue to adjust index as the sponsoring index company makes periodic additions or deletions to the index. However, the Fund/ETF may also choose not to do so.

Since this invention describes a process for variable weightings and at variable time intervals of index mutual funds/ETFs, a third category of Mutual Fund investing and a second category of ETF is described. By systematically overweighting better performing index components and systematically underweighting lesser performing index performance and using computers to optimize the weightings and the timing of reweightings the goal of increased index fund performance can be realized for minimal relative costs while maintaining security diversification and index type liquidity enabling relatively large amounts of capital to enter and exit the index with little price slippage.

Two technical indicators (Relative Strength and Alpha) focusing exclusively on price would be used to determine daily rebalancing weights of the components. The relative strength and alpha numbers would be determined at fixed intervals from as often as one day to as long as one year. Computer optimization through both back testing and forward testing can be used to help Index fund management to determine the precise time interval and component weightings to use.

A relative strength (and/or alpha) number would be assigned to each component and compared to either the underlying index of which the component is a member or a broader index (i.e. S&P 500, Dow Industrials), which the index manager wishes the component performance to be compared. A security rising faster than the underlying index being compared to would have a relative strength number or greater than 50 and less than 100. A securities price rising slower than the index would have a relative strength number of less than 50 and greater than 1. Thus, all index components would be assigned a periodic ranking of from 1 to 99 at specific time intervals determined by the index managers.

The index portfolio would be more heavily weighted with stock components having higher relative strength numbers that are rising and underweighted with stock components which have low RS number and all falling. A change in reweighting rebalancing intervals would occur periodically. Daily index rebalancing according to net buying and selling from customers orders would occur as usual to establish a daily NAV (net asset value) as currently required by government regulators.

A variable number of time periods can be used to recalculate the relative weightings. (i.e., weekly time periods). Periodic review of relative weightings can be done by fund management (i. e., Evaluation Frequency can be Yearly, Quarterly, Monthly, Bi-Weekly, or Daily).

Computers and software can be used to assist in determining the ideal weightings and the frequency of weightings evaluations by management through use of an optimization process, which includes back testing, a process is used to test various RS and Alpha Weightings to determine an optimal weighting.

An additional indicator, known as alpha, would be calculated on every index component and used in the index component weighting decisions. These formulas for alpha and relative strength would be reduced to computer code. The computer code in the form of usable software would be used to determine optimized component weighting levels and as well as optimized time intervals to review the weightings and suggest the shift in relative strength and alpha weighting to be shifted among the index components

The amount of index component purchases and/or sells each day would be a function of both predetermined stock weightings and the index owners demand to buy and this particular index on a particular day.

Relative Strength is calculated with a Relative Strength Index (RSI) Equation:
RSI=100−[100/1+RS],

where Relative Strength (RS)=Average of x # of day's closes up/Average of x # of day's close down.

For an example of x=14 days, the procedure is as follows:
(1) Obtain the sum of the UP closes for the previous 14 days and divide this sum by 14. This is the average UP close.
(2) Obtain the sum of the down closes for the previous 14 days and divide this sum by 14. This is the average down close.
(3) Divide the average UP close by the average DOWN close to obtain the Relative Strength (RS).
(4) Add 1.00 to the RS.
(5) Divide the result obtained in Step 4 into 100.
(6) Subtract the result obtained in step 5 from 100. This is the first RSI.

Moving forward, it is only necessary to use the previous average UP close and the previous average DOWN close in the calculation of the next RSI. This procedure alters the above steps (1) and (2) as follows.
1. To obtain the next average UP close, multiply the previous average UP close by 13 and add to this number today's UP close and divide the total by 14.
2. To obtain the next average down close, multiply the previous average DOWN close by 13 and add to this number today's DOWN close and divide the total by 14.
   Steps (3), (4), (5) and (6) are the same as the initial RSI.

The following Relative Strength (RS) Weighting examples are for a Normal Weighting of 1.0:

### EXAMPLE 1

95% or higher RS rating weighted 3×normal weighting

5% or lower RS rating weighted 0.25×normal weighting

### EXAMPLE 2

90%-95% RS rating weighted 2.5×normal weighting

5%-10% RS rating weighted at 0.33×normal weighting

### EXAMPLE 3

85% -90% RS rating weighted 2.0×normal weighting

10% -15% RS rating weighted 0.50% normal weighting

### EXAMPLE 4

80%-85% RS rating weighted 1.5×normal weighting

15%-20% RS rating weighted 0.75% normal weighting

For these examples, calculations and adjustments to list are made on a weekly basis. Quarterly reevaluation of weightings are made with computer optimization.

Definition of Alpha and How it is Used

ALPHA, Raw ALPHA, Weighted ALPHA, and Raw Weighted ALPHA. The Alpha is a measure of how much a stock has risen or fallen, typically over a one-year period. However, alpha can also be defined as any absolute against an index (broad or narrow) for a much shorter period of time. For example, alpha could be expressed as 15 days positive price increase either against a stock price itself or against an underlying index. Of course an explanation of how alpha is currently defined should accompany the alpha numbers calculated.

Original research of alpha was restricted to large cap stocks, so the corresponding rise in the S&P 500 index was subtracted. There are a number of stocks that do not fit well into any category and others that fit into more than one category. Our calculations will be presented either without subtracting any index or subtracting the index with which they are more closely identified.

If no index alpha is subtracted then the term Raw Alpha is used.

Weighted Alpha: First how much a stock has changed in a one-year period is determined. Then more weight is assigned at the most recent period and less weight (for example, 0.5) at the beginning of the period. A weighted alpha is a measure of one-year growth with an emphasis on the most recent activity and then subtracting the growth of its underlying index.

Raw Weighted Alpha is a Weighted Alpha without subtracting the underlying index. The defined the default time period for alpha calculations is one year.)
A stock that has risen over the one year period will have a positive Raw Weighted Alpha.
stock that has not changed or has changed very little will have a zero or small Weighted Alpha.
stock whose price has dropped over the period will have a negative Weighted Alpha.
   Subtracting the change of an index from alpha will lower the alpha number but lower it on a relative basis as long as the same index is used in comparison or stock alphas.

Characteristics of Alpha include the following:
Alpha can be measured for any time period (but most typically for a one year time frame)
Alpha can be a measured of the security against itself
Alpha can be a measured of the security against a specified underlying index
Alpha can be a measured that is either weighted equally among the days, weeks, months, or years for which it is measure or weighted more heavily toward the more recent times frame periods either days, weeks, months, or years.

The following are examples of Relative Weightings of Alphas, for a one-year period of Alpha Weightings:

### EXAMPLE #1

| Period of the Year | Alpha Weighting |
|---|---|
| Quarter One Beginning three month period | X 0.50 |
| Quarter Two Second three month period from the | X 1.00 |
| beginning | |
| Quarter Three Third three month period from the | X 1.00 |
| beginning | |
| Quarter Four Most recent period | X 2.00 |

### EXAMPLE #2

| Period of the Year | Alpha Weighting |
|---|---|
| Quarter One | X 0.50 |
| Quarter Two | X 1.00 |
| Quarter Three | X 2.00 |
| Quarter Four | X 4.00 |

### EXAMPLE #3

| Period of the Year | Alpha Weighting |
|---|---|
| Bimonthly One | X 0.50 |
| Bimonthly Two | X 1.00 |
| Bimonthly Three | X 1.00 |
| Bimonthly Four | X 1.00 |
| Bimonthly Five | x 2.00 |
| Bimonthly Six | x 4.00 |

### EXAMPLE #4

| Period of the Year | Alpha Weighting |
|---|---|
| Semiannual One | X 1.00 |
| Semiannual Two | X 2.00 |

### EXAMPLE #5

| Period of the Year | Alpha Weighting |
|---|---|
| Semiannual One | X 0.50 |
| Semiannual Two | X 2.00 |

### EXAMPLE #6

| Period of the Year | Alpha Weighting |
|---|---|
| Month One | X 0.25 |
| Month Two | X 0.50 |
| Month Three | X 0.75 |
| Month Four | X 1.00 |
| Month Five | X 1.00 |
| Month Six | X 1.00 |
| Month Seven | X 1.00 |
| Month Eight | X 1.00 |
| Month Nine | X 1.00 |
| Month Ten | X 1.25 |
| Month Eleven | X 1.50 |
| Month Twelve | X 2.00 |

### EXAMPLE #7

15 day alpha unweighted

### EXAMPLE #8

30 day alpha unweighted

### EXAMPLE #9

45 day alpha unweighted

### EXAMPLE #10

60 day alpha unweighted against the underlying index

### EXAMPLE #11

180 day alpha unweighted against the underlying index

### EXAMPLE #12

180 day alpha weighted most recent month×2, months 2, 3, 4, 5, and 6×1 against the underlying index

### EXAMPLE #13

90 day alpha weighted most recent month×2. Months 2 and 3 both×1. Measured against the security itself.

The following are examples of use of RS and Alpha in combination:

### EXAMPLE #1

Both RS and Alpha 95% or greater for the Index group evaluated Weighted at 3×normal weightings

### EXAMPLE #2

Both RS and Alpha 90% or greater for the Index group evaluated Weighted at 2.5×normal

### EXAMPLE #3

RS greater than 95% and Alpha greater than 90% for Index group evaluated Weighted at 2×normal weightings

### EXAMPLE #4

RS greater than 80% and Alpha greater than 90% for Index group evaluated Weighted at 1.5×normal weightings

### EXAMPLE #5

RS greater than 85% and an absolute 15 day positive Alpha of 0.15 as compared to the underlying index group.

### EXAMPLE #6

RS greater that 75% and an absolute 30 day positive Alpha of 0.25 as compared to the underlying security itself.

The method describes the use of alpha (with a corresponding rise of an index subtracted), Raw alpha (no index subtracted), Weighted Alpha (with a corresponding rise of an index subtracted) and time periods weighted to variable specifications, and Raw Weighted Alpha (no index subtracted) and weighted to variable specifications as depicted in the above examples.

Mutual Fund/ETF Indexes can be weighted by using RS and Alpha as determinates of the relative weightings either alone or in combination.

Change of Weightings in Relative Strength (RS) and Alpha. A flexible process where management can change index weightings using RS and/or Alpha at any time is described. Computer optimization is a very important tool in evaluating the weighting changes. Some reasons that may suggest that a weighting change is needed include changes in the characteristics of the market as a whole. Such as change in market from trending up to trending sideways, market from trending sideways to trending down, market trending up to market trending down, market trending down to market trending up, price volatility changing from high to low or price volatility changing from low to high.

Although a quarterly review of mutual fund index/ETF weightings with the aid of a computer optimization process can provide a time benchmark, the frequency of review is flexible can be done as frequent or infrequently as management deems and in sync with current market conditions. Index weightings can be done using RS (relative strength) exclusively, or using alpha (clearly defined) exclusively. Index weightings also can be determined using RS and Alpha together. Using the power of the computer processing chip and software thousands of computations and permutations can be rapidly calculated to aid in determining the optimal index weightings for the current market environment of equity, bonds, and or hybrid (equity and bond) portfolios.

The present invention provides:
Index Portfolios weightings modifications using Relative Strength of the index components against the underlying index or against another broad index (i.e. S&P 500)
Index Portfolio weightings modifications using Alpha of the individual index components against the underlying index or against another broad index (i.e. S&P 500)
Index Portfolios weightings modifications using Relative Strength and Alpha in combination at various weighting percentages. (i.e. Relative Strength 50% and Alpha 50%)
Alpha may be defined as Alpha, Raw Alpha, Weighted Alpha, or Raw Weighted Alpha in terms of how alpha is calculated and used in the formula for index portfolio weightings (see definitions above)

Index and market products suitable for use with the weighting modification system of the present invention, for example, include the following:
Index Portfolios including Mutual Index Funds (Equity, Bond, Hybrid)
Exchange Traded Funds (Equity, Bonds, and Hybrid).
Real Estate Investment Trusts (REITs)
Traditional Bond Portfolios

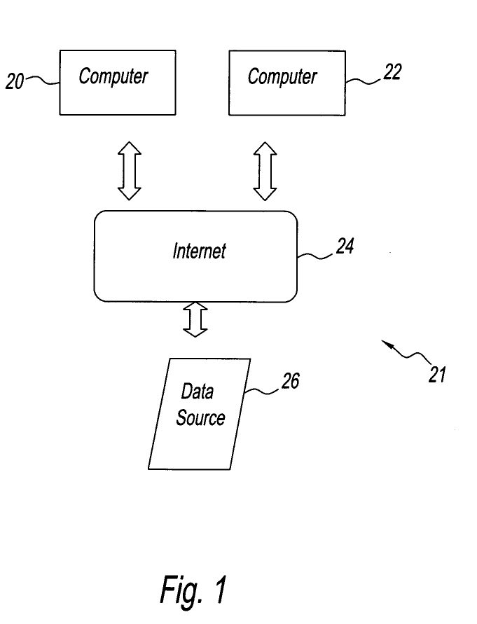

Referring now to FIG. 1, a system 21 of the present invention comprises a fund manager computer 20, a client or investor computer 22 and a data source 26 that are interconnected via a communication network, shown as an Internet 24. Fund manager computer 20 may be a single computer as shown or may in alternate embodiments be comprised of one or more computers. Client computer 22 is a computer used by one or more investor clients to obtain investment information from fund manager computer 20. It will be appreciated by those of skill in the art that client computer 22 is one of many client computers that communicate with fund manager computer 20 via Internet 24. Data source 26 comprises one or more databases that provide data concerning securities, particularly those contained in the portfolio being managed by fund manager computer 20.

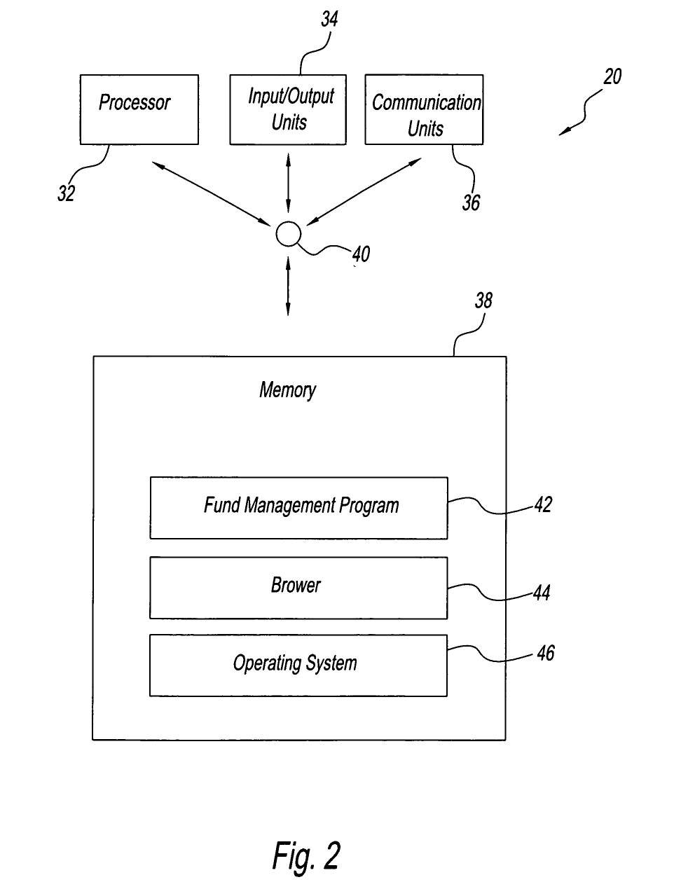

Referring to FIG. 2, fund manager computer 20 comprises a processor 32, one or more input/output (I/O) units 34, at least one communication unit 36 and a memory 38 that are all interconnected by a bus 40. I/O units 34, for example, may include input devices, such as a keyboard, a mouse or other suitable input device and output devices, such as a display, a printer and any other suitable output device.

Memory 38 may comprise one or more types of memory, such as random access, read only, flash, disk drives of any type and the like. Stored in memory 38 are a plurality of programs that include a fund management program 42, a browser 44 and an operating system 46. It will be apparent to those skilled in the art that many other programs may be resident in memory 38.

In operation, processor 32 executes or runs a plurality of instructions of fund management program 42 to provide the functionality of the method and system of the present invention. Processor 32 cooperates with browser 44 and communication unit 36 to communicate with data source 26 and client computer 22 via internet 24.

It will be appreciated by those skilled in the art that client computer 22 may be similar to computer 20, but would not be provided with fund management program 42.

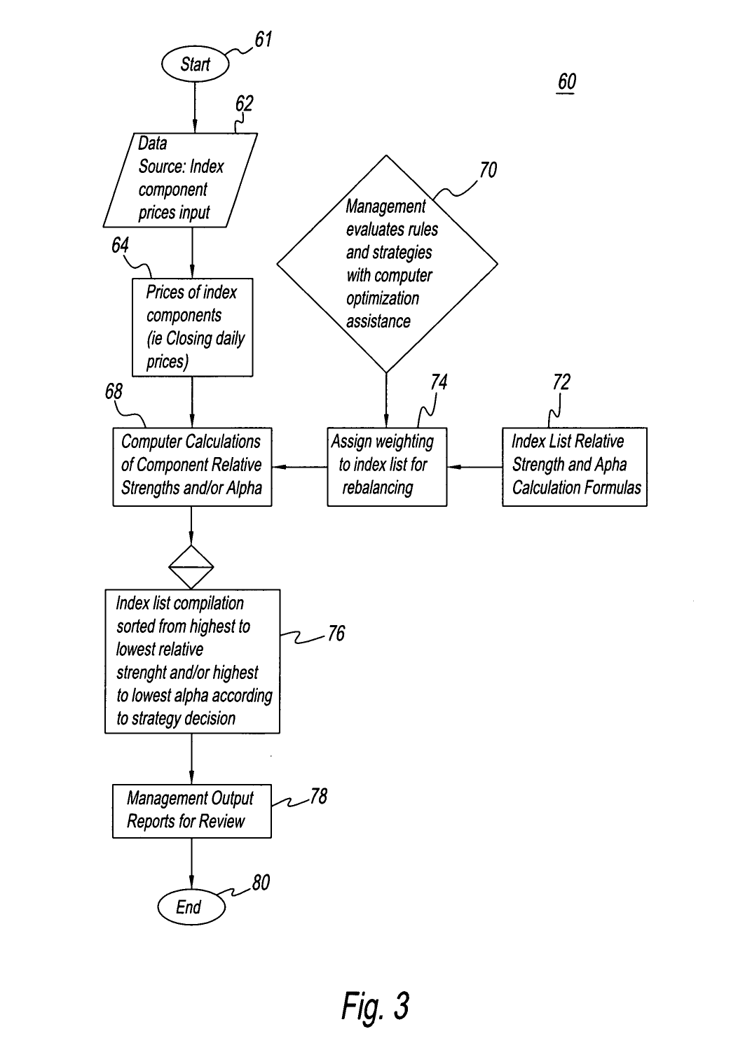

Referring to FIG. 3, fund management program 42 comprises a program process 60 for index component weighting and frequency of data input. Process 60 when initiated at start 61 obtains at step 62 from data source 26 prices of the index components contained in the fund portfolio. This price data may be obtained from recognized major exchanges (for example, New York Stock Exchange, American Exchange, NASDAQ, CBOE or others) where the index components are traded. A process 66 is run to obtain data (e.g., prices of index stock components) for an index and index product as originally structured , for example, Standard and Poor indexes, Dow Jones indexes and/or others.

At step 64, the index component price data obtained by step 62 is processed to provide prices of the index components at a specified periodicity, e.g., daily, hourly, twice a day or other period.

At step 70, the fund management personnel evaluate rules and strategies of the fund with the aid of computer optimization assistance. Any needed changes, such as weighting for relative strength and/or alpha, are input via I/O units 34. At step 74, based on input from step 70, weighting is assigned to the relative strength and alpha of the index components list provided by step 72. At step 68, the relative strength and alpha calculations are performed for the index components based on the price data provided from step 64. At step 76, the index list is compiled based on a sort from highest to lowest relative strength and/or alpha according to any strategy decision entered via step 70 by management personnel. At step 78, output reports of the compiled list are generated for review by management. Process 60 ends at step 80.

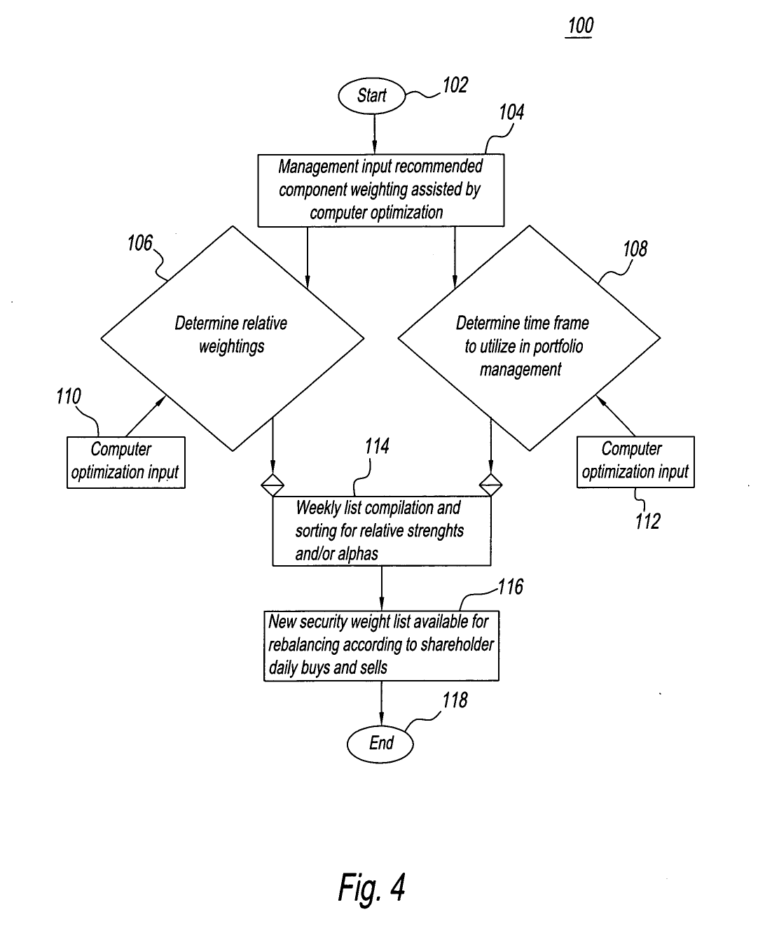

Referring to FIG. 4, fund management program 42 comprises a program process 100 for determining index weightings. Upon initiation at step 102, step 104 waits for management input regarding index component weighting. Management's recommendations may be developed with the aid of computer optimization. Step 106 determines the relative weightings for relative strength and/or alpha. For example, index components in the upper 10% are weighted by 2.0 and index components in the lower 10% are weighted by 0.5.

Step 108 determines the time-frame to be used in managing the portfolio of index components. For example, a weekly definition use 5 days of market data or less based on holidays or other circumstances. The determinations made by steps 106 and 108 may be aided by computer optimization input provided by steps 110 and 112, respectively.

Step 114 compiles a weekly list using a sort of the index components based on relative strength and/or alpha data provided by step 106 and frequency data (e.g., weekly) provided by step 108. Step 116 generates a new index component list for fund rebalancing purposes, which may be executed based on shareholder buy and sell data. Process 100 ends at step 118.

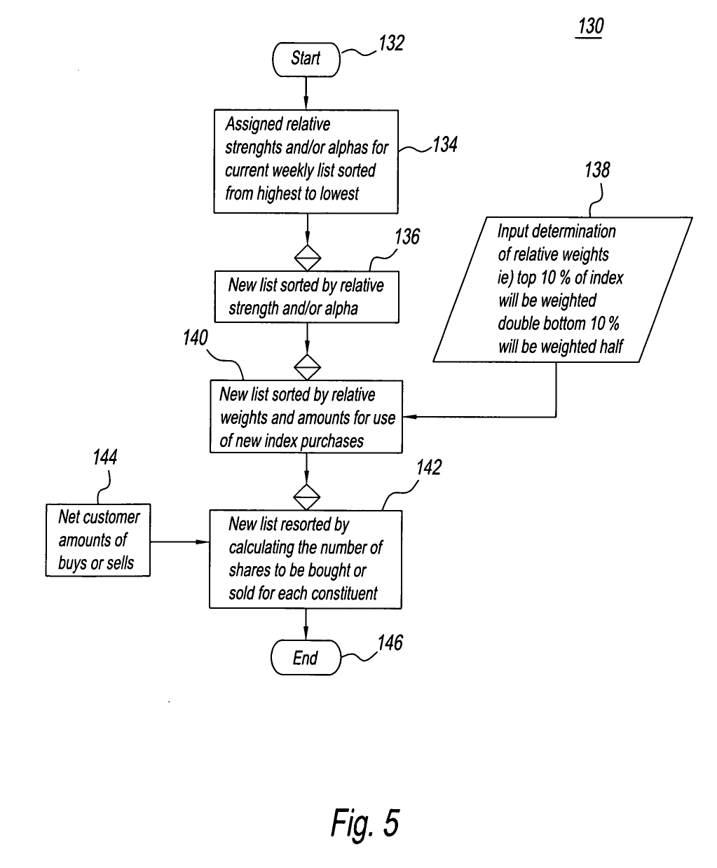

Referring to FIG. 5, fund management program 42 comprises a program process 130 for sorting the index list. Process 130 can be run at any suitable intervals. For example process 130 can be run daily and at multiple intervals intra day. Upon initiation at step 132, step 134 assigns relative strengths and/or alphas for the current weekly list sorted from highest to lowest. Step 136 sorts the new weekly list provided by step 134 by relative strength and/or alpha. Step 138 provides relative weights based on input from fund management personnel. The relative weights, for example, may be a weight of 2.0 for the top 10% of the components and 0.5 for the bottom 10% of the components in the list. The list sorted by step 136 is further sorted by step 140 by relative weights and amounts for use of index component purchases and sales. Step 144 provides a net amount of new funds from customers for buys and sells of the fund. Step 142 calculates the number of shares of each component to be bought or sold based on the available net customer funds and generates a new list with the share numbers of the components to be bought or sold. Process 130 ends at step 146.

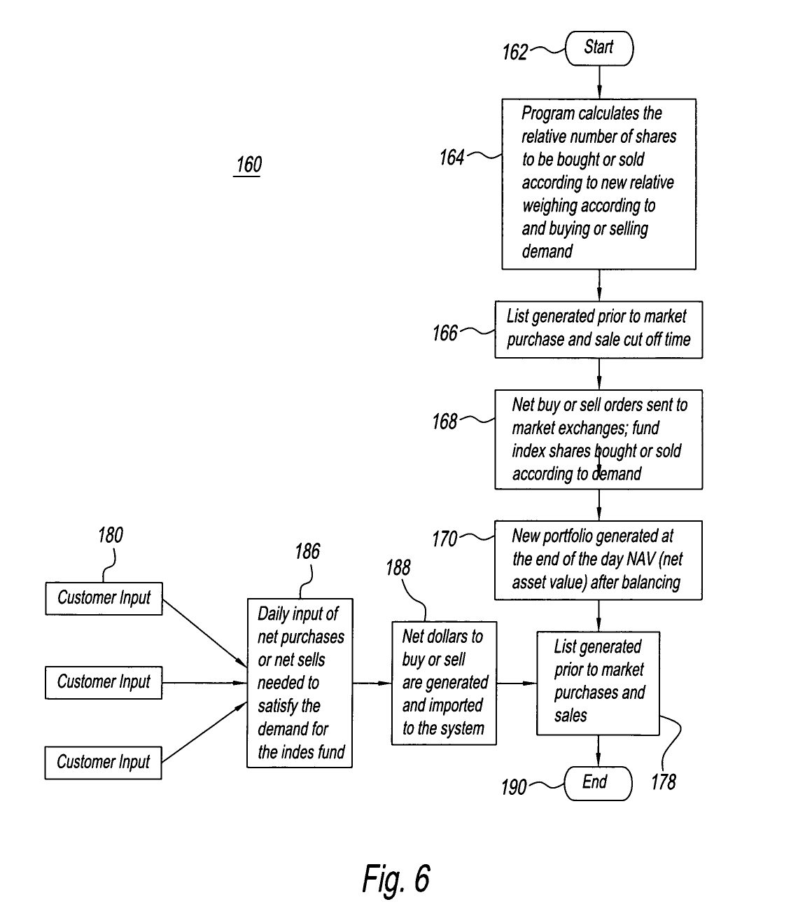

Referring to FIG. 6, fund management program 42 comprises a program process 160 for a one day balancing cycle. Upon initiation at step 162, step 164 calculates the relative number of shares of each component to be bought or sold based on new relative weight with the available net customer funds from purchase and sale of fund shares. Step 166 generates a fund list of index components for purchase and/or sale prior to market purchase and sale cut off time. Step 168 sends the net buy and sell orders for the index components to the appropriate exchanges. For example, if the NAV (net asset value) of an open ended index fund is $100 per share, and the funds investors wish to buy $1,000,000 of this index fund for a current day, a total of 10,000 new shares of this fund would be created for the current day. Step 170 generates a new portfolio at the end of the trading day by (NAV) after balancing.

Step 180 comprises the daily input of customer orders for purchase and sale of fund shares from a client computer 22 or via other communication, such as telephone, facsimile and the like. Step 186 captures the daily customer input of net buy and/or sell orders of fund shares. Step 188 calculates net available funds from the net customer purchases and sales of fund shares. Step 178 generates a fund list of index components for purchase and/or sale prior to market purchase and sale cut off time for the next day. Process 160 ends at step 190.

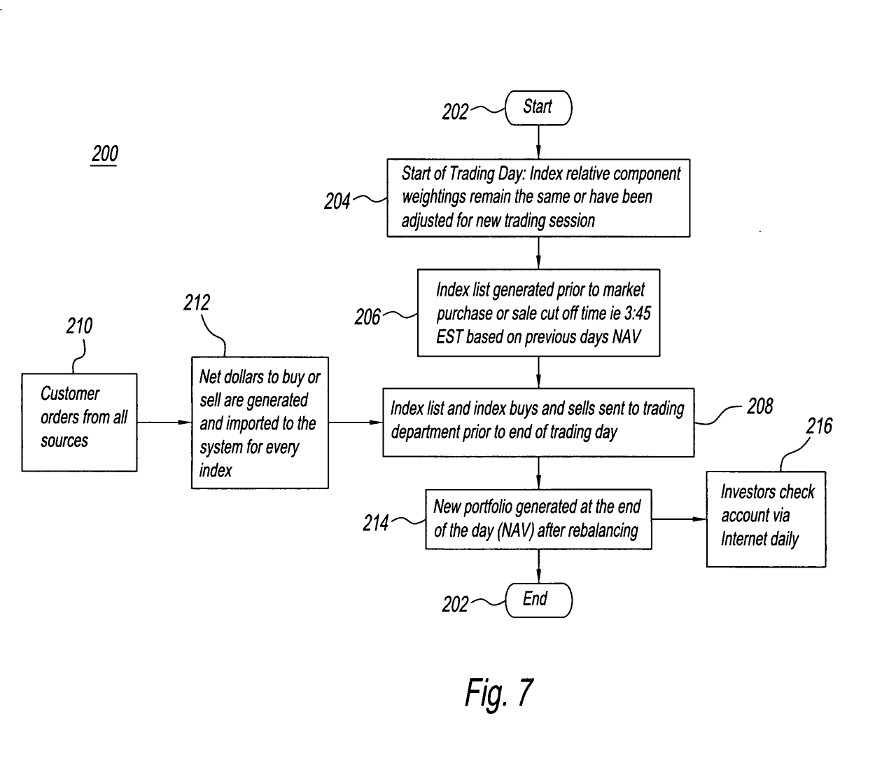

Referring to FIG. 7, fund management program 42 comprises a program process 200 for a daily rebalancing cycle. Process 200 is preferably used on a daily basis. In alternate embodiments, process 200 can be run according to any desired frequency of occurrence. For example, process 200 could be run twice a day, hourly, or every 30 minutes throughout a market day. Upon initiation at step 202, step 204 determines at the start of the day whether the relative weights remain the same or have been adjusted for the new trading session. Step 206 generates the index list prior to market purchase or sale cut off time (e.g., 3:45 EST) based on the previous day's NAV. Step 210 captures customer orders for purchase and sale of fund shares from all sources. Step 212 calculates the net dollars available for purchase or sale of index components based on the captured customer orders. Step 208 generates and sends a list of index component buy and sell orders to the trading department for execution prior to the end of the trading day. Step 214 generates a new portfolio at the end of day after rebalancing. Step 216 comprises customers checking their account via Internet 24. Process 202 ends at step 218.

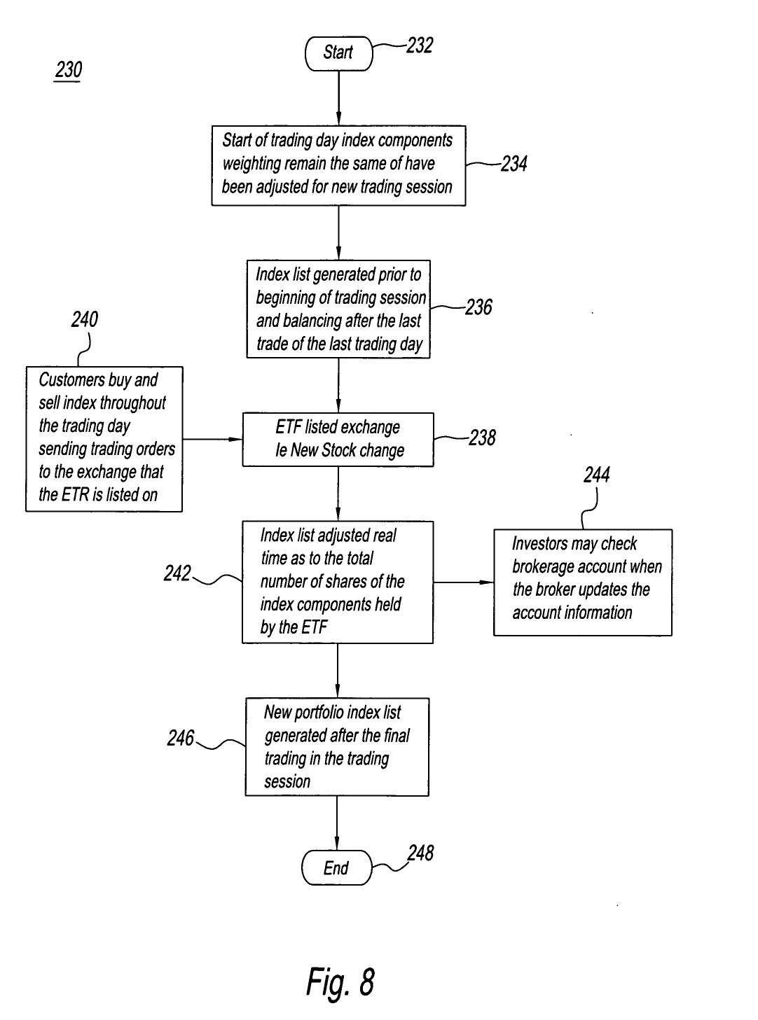

Referring to FIG. 8, fund management program 42 comprises a program process 230 for a real time rebalancing cycle for EFTs. Process 230 is preferably used on a daily basis. In alternate embodiments, process 230 can be run according to any desired frequency of occurrence. For example, process 230 could be run twice a day, hourly, or every 30 minutes throughout a market day. Upon initiation at step 232, step 234 determines at the start of the day whether the relative weights remain the same or have been adjusted for the new trading session. Step 236 generates the index list prior to the beginning of the trading session and balancing after the last trade of the previous trading day. Step 240 depicts customer orders for purchase and sale of the ETF shares throughout the trading day. Step 238 depicts the exchange upon which the ETF is listed. Step 242 adjusts the ETF list of fund components in real time as to the total number of shares held by the ETF. Step 244 depicts investors checking their account information for any updates posted by their respective brokers. Step 246 generates a new portfolio index list after the trading session ends. Process 230 ends at step 248.

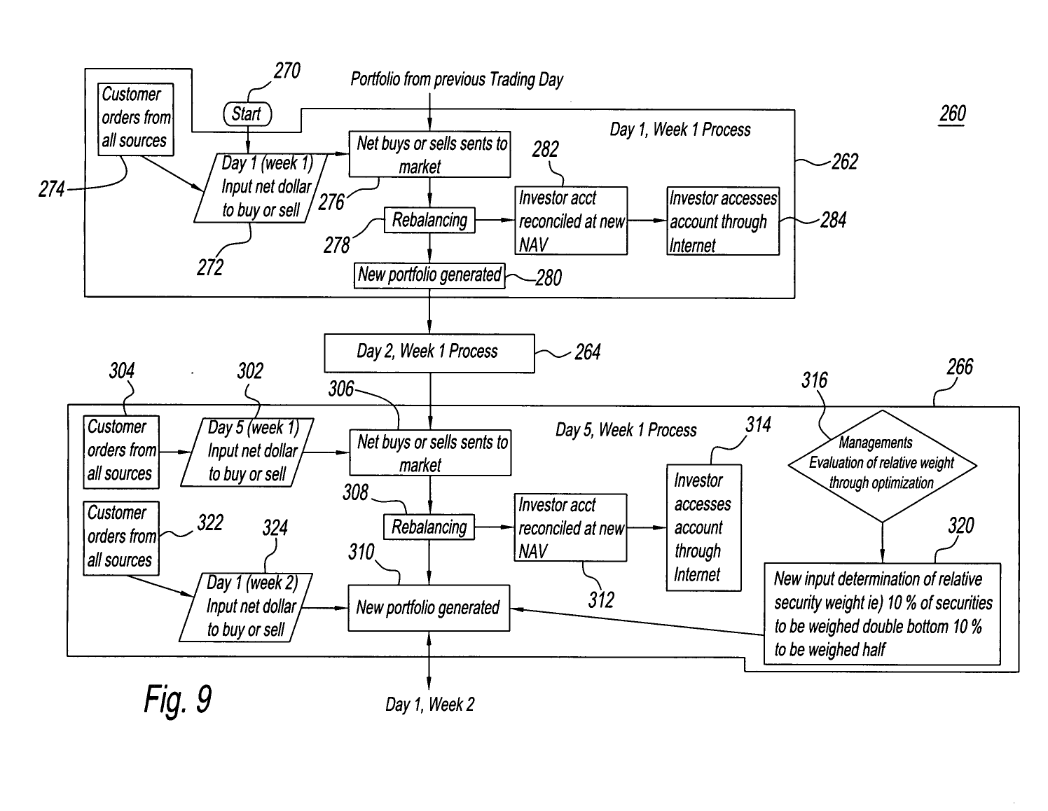

Referring to FIG. 9, fund management program 42 comprises a program process 260 for a one week cycle with daily rebalancing and weekly adjustment of weighting. Process 260 comprises a day 1 week 1 process 262, a day 2 week 1 process 264, day 3 week 1 process, day 4 week 1 process and a day 5 week 1 process 266. Day 1 week 1 process 262, day 2 week 1 process 264, day 3 week 1 process and day 4 week 1 process are substantially identical, so only day week 1 process 262 will be described in detail. Day 2 week 1 and day 3 week 1 processes are not shown on the drawing, but are indicated by the dashed line between day 2 week 1 process 264 and day 5 week 1 process 266.

Upon initiation at step 270, step 272 calculates net dollars or available funds based on customer orders to sell and buy fund shares captured by step 274. Step 276 allocates the net available funds to the components of the portfolio of the previous trading day (e.g., day 5 or the preceding week). Step 278 rebalances the portfolio based on the component characteristic (relative strength and/or alpha) as described above for FIGS. 5 and 7. Step 280 generates a new portfolio, which serves as an input to day 2 week 1 process 264. Step 282 reconciles the investor accounts per the net asset value (NAV) at the close of trading for day 1 week 1. Step 284 enables investors to access their accounts via Internet 24.

Day 5 week 1 process 266 at step 302 calculates net dollars or available funds based on customer orders to sell and buy fund shares captured by step 304. Step 306 allocates the net available funds to the components of the portfolio of the previous trading day (e.g., day 4 week 1). Step 308 rebalances the portfolio based on the component characteristic (relative strength and/or alpha) as described above for FIGS. 5 and 7. Step 312 reconciles the investor accounts per the net asset value (NAV) at the close of trading for day 5 week 1. Step 314 enables investors to access their accounts via Internet 24.

Based on customer orders for purchase and sale of fund shares over a weekend or holiday, step 324 calculates net dollars or available funds based on customer orders to sell and buy fund shares captured by step 322. Based on these net available funds, orders are sent to market. Step 316 captures any input of relative weight entered by an operator or a computer optimization. Reweighting can be done periodically, e.g., quarterly or other period, or upon the occurrence of some significant event, such as, an earthquake, a hurricane, act of war and other events. Step 320 provides a relative weighting based on any input from step 316. This weighting can be unchanged or changed based on the determination of step 316. Step 310 generates a new portfolio, based on the weighting provided by step 320. Step 320

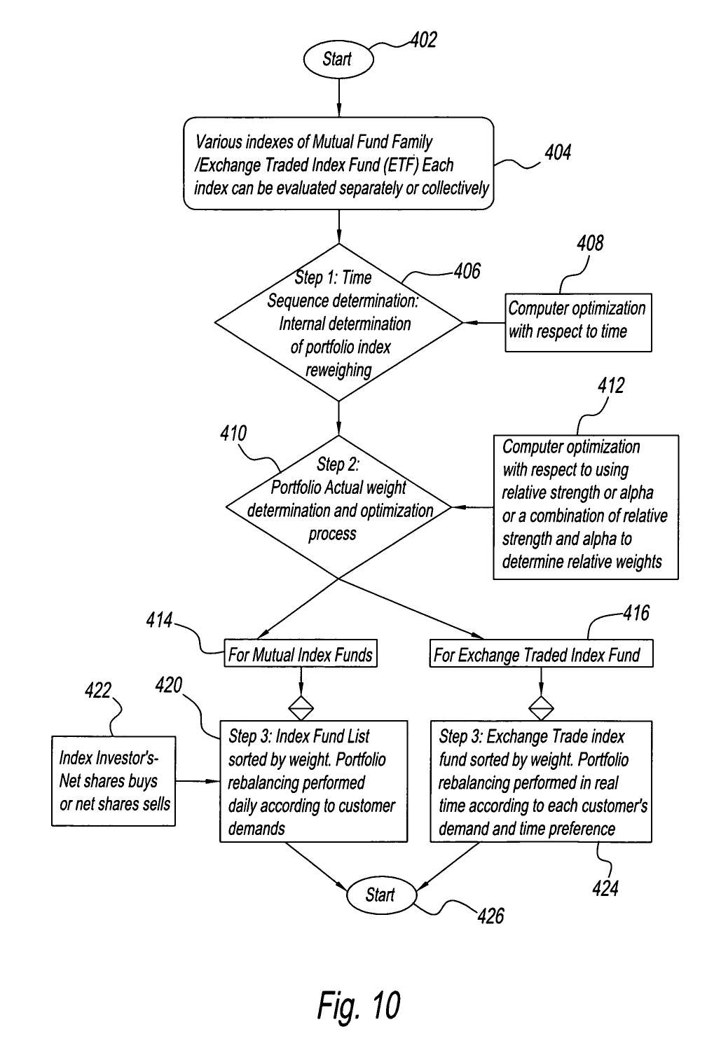

Referring to FIG. 10, fund management program 42 comprises a program process 400 for a determination of index weighting. Upon initiation at step 402, step 404 gets index data from data source 26 as needed. The needed data could be, for example, various indexes of a mutual fund family, or an ETF. Each index can be evaluated independently or collectively. Step 406 makes a time sequence determination, i.e., an internal determination of portfolio reweighting based on computer optimization with respect to time provided by step 408. Step 412 uses a computer, such as computer 20, to optimize weight with respect to using relative strength, alpha or a combination thereof to determine relative weights. Any suitable optimization program, such as Trade Station or other optimization program can provide the optimization. At step 410, index fund management makes a portfolio actual weight determination based on the computer optimization result of step 412. At step 412, index fund management decides to accept, reject or change the optimization suggestions provided by step 412. Step 414 provides a list of the weighting of the index components approved by step 410. Step 416 provides a list of the weighting of the index components approved by step 410 for an ETF based on the actual weight determination of step 410. Step 420, based on the net available dollars from customer buying and selling of fund shares, sorts or ranks the components of a fund index by weight for daily rebalancing according to investor net buy and sell demand for the time period under consideration, e.g., one day. Step 424 sorts or ranks the components of an EFT by weight for daily rebalancing according to investor net buy or sell demand. Process 400 ends at step 426.

The present invention having been thus described with particular reference to the preferred forms thereof, it will be obvious that various changes and modifications may be made therein without departing from the spirit and scope of the present invention as defined in the appended claims.

What is claimed is:

1. A system for managing a fund portfolio that includes a plurality of components, said system comprising:
a computer that includes a program that is executed at a repetitive frequency, said program comprising a plurality of instructions that cause said computer to:
calculate at least one dynamic characteristic of said components based on current price data for each of said components;
rank said components in descending order based on said calculated characteristics; and
rebalance said fund portfolio based on a weighting strategy, which is applied to said descending order rank.

2. The system of claim 1, wherein said characteristic is selected from the group consisting of: relative strength, alpha and both relative strength and alpha.

3. The system of claim 1, wherein said fund portfolio is rebalanced using net funds available from customers based on buy and sell orders of said fund.

4. The system of claim 1, wherein said repetitive frequency is selected from the group consisting of: yearly, monthly, weekly, daily and any fraction thereof.

5. The system of claim 1, wherein said fund is selected from the group consisting of: index fund, exchange traded fund, real estate investment trust, and bond fund.

6. The system of claim 1, wherein said weighting strategy comprises a first weighting factor to overweight better performing components and a second weighting factor to underweight lesser performing components.

7. The system of claim 6, wherein said first and second weighting factors are applied to a first predetermined number of top and a second predetermined number of bottom components of said descending order list, respectively.

8. The system of claim 1, wherein said instructions further cause said computer to adjust said weighting strategy at any time based on operator input.

9. The system of claim 1, wherein said calculation of the dynamic characteristic is further based on a like characteristic of a broad or underlying index.

10. A method for managing a fund portfolio that includes a plurality of components, said method comprising:
using a computer that includes a program that is executed at a repetitive frequency, said program comprising a plurality of instructions that cause said computer to perform a plurality of steps comprising:
calculating at least one dynamic characteristic of said components based on current price data for each of said components;
ranking said components in descending order based on said calculated characteristics; and
rebalancing said fund portfolio based on a weighting strategy, which is applied to said descending order rank.

11. The method of claim 10, wherein said characteristic is selected from the group consisting of: relative strength, alpha and both relative strength and alpha.

12. The method of claim 10, wherein said fund portfolio is rebalanced using net funds available from customers based on buy and sell orders of said fund.

13. The method of claim 10, wherein said repetitive frequency is selected from the group consisting of: yearly, monthly, weekly, daily and any fraction thereof.

14. The method of claim 10, wherein said fund is selected from the group consisting of: index fund, exchange traded fund, real estate investment trust, and bond fund.

15. The method of claim 10, wherein said weighting strategy comprises a first weighting factor to overweight better performing components and a second weighting factor to underweight lesser performing components.

16. The method of claim 15, wherein said first and second weighting factors are applied to a first predetermined number of top and a second predetermined number of bottom components of said descending order list, respectively.

17. The method of claim 10, wherein said instructions further cause said computer to adjust said weighting strategy at any time based on operator input.

18. The method of claim 10, wherein said calculation of the dynamic characteristic is further based on a like characteristic of a broad or underlying index.

19. A memory media for a computer comprising:
a stored program with a plurality of instructions that cause said computer to:
calculate at least one dynamic characteristic of said components based on current price data for each of said components;
rank said components in descending order based on said calculated characteristics; and
rebalance said fund portfolio based on a weighting strategy, which is applied to said descending order rank.
